(19) United States
(12) Patent Application Publication
(10) Pub. No.: US 2006/0117913 A1
(43) Pub. Date: Jun. 8, 2006

(54) Selective one-way wrench

(76) Inventor: Terence Chen, Lo Tung Town (TW)

Correspondence Address: CHARLES E. BAXLEY, ESQ., 90 JOHN STREET, THIRD FLOOR, NEW YORK, NY, 10038, US

(21) Appl. No.: 11/334,780

(22) Filed: Jan. 17, 2006

Related U.S. Application Data
(63) Continuation-in-part of application No. 10/648,205, filed on Aug. 27, 2003.

(51) Int. Cl. B25B 13/46

(52) U.S. Cl. 81/63.1

(57) ABSTRACT

A selective one-way wrench includes a handle and a head from which the handle projects. The head defines a first space, a second space in communication with the first space, a third space in communication with the second space and an aperture. An annular gear is rotationally positioned in the first space. A direction controller is positioned in the second space. The direction controller includes two pawls and a spring installed between the pawls. The direction switch is partially positioned in the third space for engaging selected one of the pawls with the annular gear. The direction switch defines a recess. A fastener is driven into the recess of the direction switch through the aperture of the head so as to pivotally install the direction switch on the head.

### CROSS-REFERENCE

The present application is a continuation-in-part application of U.S. patent application Ser. No. 10/648,205 of which the entire disclosure is incorporated herein.

### BACKGROUND OF INVENTION

1. Field of Invention

The present invention relates to a selective one-way wrench.

2. Related Prior Art

Referring to FIGS. 9-12, a conventional selective one-way wrench 50 includes a handle 52 and a head 54 formed on the handle 52. The head 54 defines a circular space 56, a crescent space 58 in communication with the circular space 56, a groove 60 on a side and a recess 62 in communication with the groove 60. A spring 64 and a detent 66 are positioned in the recess 62. A direction switch 68 is positioned in the groove 60 movably. A friction plate 70 is formed on the direction switch 68 for contact with a user's finger. The direction switch 68 defines two recesses 72 and 74 on a side and a space 76 on an opposite side. The detent 66 is positioned in the recess 72 or 74 for keeping the direction switch 68 in selected one of two positions. The friction plate 70 defines an aperture 78 in communication with the space 76. A V-shaped spring 80 includes two ends 82 and 84. The spring 80 is positioned in the space 76. A tab 86 is inserted in the space 76 for preventing the spring 80 from faltering in the space 76. The tab 86 defines an aperture 88. A pin 90 is fit in the apertures 78 and 88 and positioned between the ends 82 and 84 so as to avoid the spring 80 escaping the space 76. A pawl 92 includes two recesses 94 and 96 defined on a side and teeth 98 formed on an opposite side. The pawl 92 is positioned in the crescent space 58. The end 82 can be positioned in the recess 94, or the end 84 in the recess 96. An annular gear 100 is positioned in the circular space 56. The annular gear 100 includes teeth 102 formed on an external side thereof for engagement with the teeth 98.

Referring to FIG. 11, the direction switch 68 is moved to a right-hand end of the groove 60 so that the detent 66 enters the recess 74. Via the spring 80, a right-hand end of the pawl 92 is moved to a right-hand end of the crescent space 58. Thus, the head 10 can drive the annular gear 100 clockwise, but not vice versa.

Referring to FIG. 12, the direction switch 68 is moved to a left-hand end of the groove 60 so that the detent 66 enters the recess 74. Via the spring 80, a left-hand end of the pawl 92 is moved to a left-hand end of the crescent space 58. Thus, the head 10 can drive the annular gear 100 counterclockwise, but not vice versa.

A problem with this conventional selective one-way wrench 50 is the delicate making and troublesome installing of the direction switch 68. It requires the tab 86 to be custom made. It requires the insertion of the tab 86 into the space 76 through the crescent space 58 after the direction switch 68 is positioned in the groove 60. It requires the fitting of the pin 90 into the apertures 78 and 88. The selective one-way wrench 50 includes other elements that need delicate fabrication and troublesome installing, e.g., the spring 80. The selective one-way wrench 50 includes a complicated structure, and therefore entails a high cost.

Disclosed in U.S. Pat. No. 6,945,141 is a reversible ratchet wrench including a handle 12 formed with a box end 11, biasing means 60, a pivotal member 50 for pivoting the biasing means 60 and a switch 40 for switching the pivotal member 50. The box end 11 defines hole 16 and a slot 17. The pivotal member 50 defines a groove 51 at an upper end. The switch 40 includes a first end 41 and a second end 42. The pivotal member 50 is positioned in the hole 16, with the upper end thereof positioned in the slot 17. The first end 41 of the switch 40 is inserted into the slot 17 and fit into the biasing groove 51. Exposed from the slot of the bulge portion 13 of the wrench 10 is the second 42 of the switch 40 for operation by a user. However, the connection of the switch 40 to the pivotal cylinder 50 is not firm.

The present invention is intended to obviate or at least alleviate the problems encountered in prior art.

### SUMMARY OF INVENTION

According to the present invention, a selective one-way wrench includes a handle and a head from which the handle projects. The head defines a first space, a second space in communication with the first space, a third space in communication with the second space and an aperture. An annular gear is rotationally positioned in the first space. A direction controller is positioned in the second space. The direction controller includes two pawls and a spring installed between the pawls. The direction switch is partially positioned in the third space for engaging selected one of the pawls with the annular gear. The direction switch defines a recess. A fastener is driven into the recess of the direction switch through the aperture of the head so as to pivotally install the direction switch on the head.

An advantage of the selective one-way wrench of the present invention is its simple structure.

Another advantage of the selective one-way wrench of the present invention is that its low cost.

Other advantages and features of the invention will become more apparent from the following detailed description in conjunction with the attached drawings.

### BRIEF DESCRIPTION OF DRAWINGS

The present invention will be described through detailed illustration of two embodiments referring to the drawings.

FIG. 1 is a perspective partial view of a selective one-way wrench according to the first embodiment of the present invention.

FIG. 2 is an exploded view of the selective one-way wrench shown in FIG. 1.

FIG. 3 is a cutaway view of a handle and a head of the selective one-way wrench shown in FIG. 2.

FIG. 4 is a cross-sectional view of the selective one-way wrench shown in FIG. 1.

FIG. 5 is a cross-sectional view of the selective one-way wrench of FIG. 1 in a counterclockwise mode.

FIG. 6 is a cross-sectional view of the selective one-way wrench of FIG. 1 in a clockwise mode.

FIG. 7 is an exploded view of a selective one-way wrench according to the second embodiment of the present invention.

FIG. 8 is a cross-sectional view of the selective one-way wrench of FIG. 7 in a clockwise mode.

FIG. 9 is an exploded view of a conventional selective one-way wrench.

FIG. 10 is a cross-sectional view of the selective one-way wrench shown in FIG. 9.

FIG. 11 is a cross-sectional view of the selective one-way wrench of FIG. 9 in a clockwise mode.

FIG. 12 is a cross-sectional view of the selective one-way wrench of FIG. 9 in a counterclockwise mode.

### DETAILED DESCRIPTION OF EMBODIMENTS

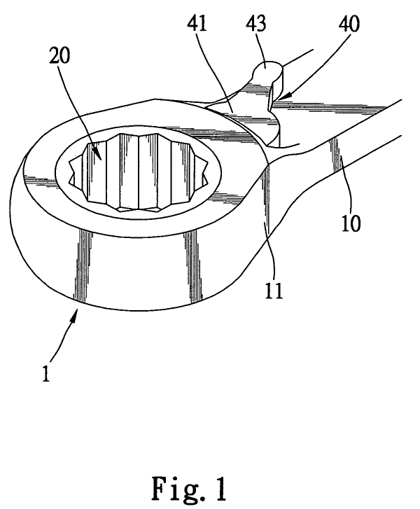

Referring to FIG. 1, according to a first embodiment of the present invention, a selective one-way wrench 1 includes a handle 10 and a head 11 formed at an end of the handle 10. The terms, “handle” and “head”, are given for the convenience of the description and not for limiting the scope of the present invention. The head 11 can be deemed a box end of the handle 11, and what are made on and in and attached to the head 11 can be deemed made on and in and attached to the handle 10.

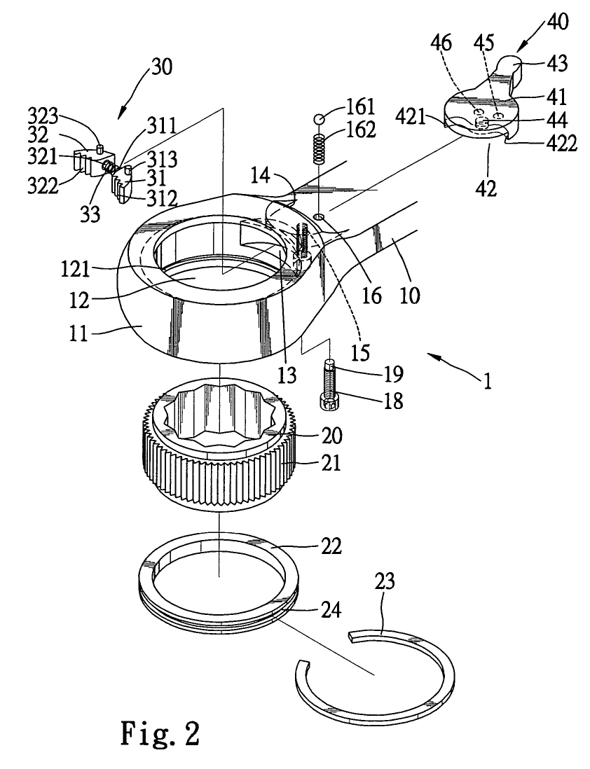

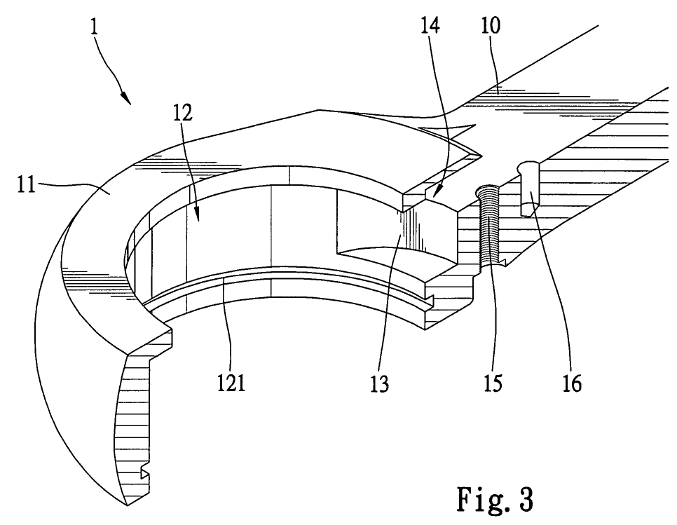

Referring to FIGS. 2 and 3, the head 11 defines a circular space 12, a crescent space 13 in communication with the circular space 12, a semi-circular space 14 in communication with the crescent space 13, an annular groove 121 on the wall of the circular space 12, a screw hole 15 and a recess 16.

A direction controller 30 is positioned in the crescent space 13. The direction controller 30 includes two pawls 31 and 32 and a spring 33 for connecting the pawl 31 to the pawl 32.

The pawls 31 includes a top, a bottom, a planar side, a toothed side 312, an arched side, a boss 311 formed on the planar side and a rod 313 formed on the top.

The pawl 32 includes a top, a bottom, a planar side, a toothed side 322, an arched side, a boss 321 formed on the planar side and a rod 323 formed on the top.

The spring 33 includes an end fit on the boss 311 and an opposite end fit on the boss 321. Thus, the pawl 31 is connected to the pawl 32 firmly by means of the spring 33.

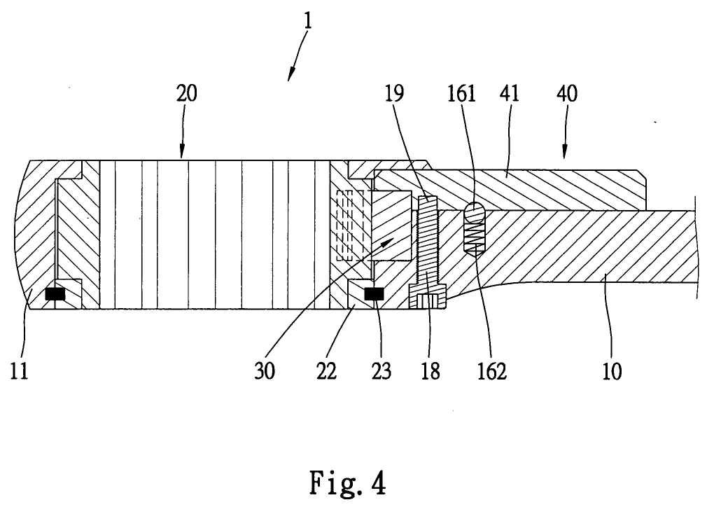

Referring to FIGS. 2 and 4, a ring 22 is positioned in the circular space 12. The ring 22 includes an annular groove 24 defined in an external face thereof.

A clip 23 is C-shaped. The clip 23 includes an internal edge positioned in the annular groove 24 and an external edge positioned in the annular groove 121. Thus, the ring 22 is firmly attached to the head 11 by means of the clip 23.

An annular gear 20 is positioned in the circular space 12. The annular gear 20 is positioned on the ring 22 rotationally. The annular gear 20 includes a toothed internal face for engagement with a bolt or nut and a toothed external face 21 for selective engagement with the pawl 31 or 32.

A spring 162 and a ball detent 162 are positioned in the recess 16.

A direction switch 40 includes a disc 41 and a lever 43 extending from the disc 41. The disc 41 includes a bottom defining a space 42 and three recesses 44, 45 and 46. The wall of the space 42 includes a first end 421 and a second end 422. The disc 41 is partially positioned in the semi-circular space 14.

A threaded bolt 18 includes a tip 19 that is smooth, i.e., non-threaded. The threaded bolt 18 is not custom made, and therefore is available at a low cost.

The threaded bolt 18 is driven into the screw hole 15. The smooth tip 19 of the threaded bolt 18 is inserted into the recess 44, thus installing the direction switch 40 on the head 11 rotationally. The ball detent 161 selectively enters the recess 45 or 46.

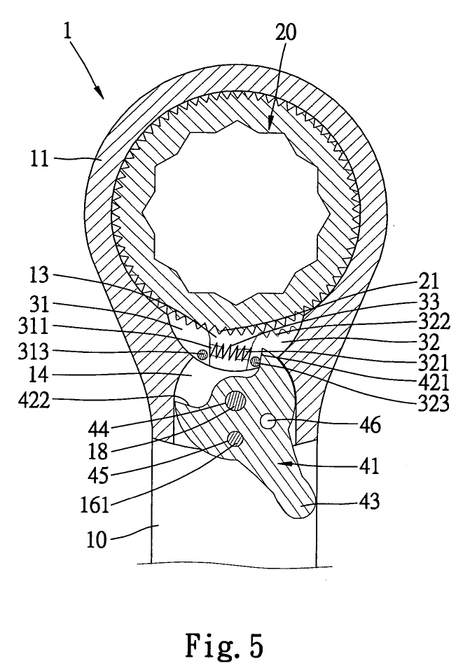

Referring to FIG. 5, the direction switch 40 is in a first position. The ball detent 16 enters the recess 46 so as to retain the direction switch 40 in the first position. The first end 421 of the wall of the space 42 pushes the rod 323. Thus, the pawl 31 is moved into a left-hand end of the crescent space 13. Thus, the head 11 can drive the annular gear 20 counterclockwise, but not vice versa.

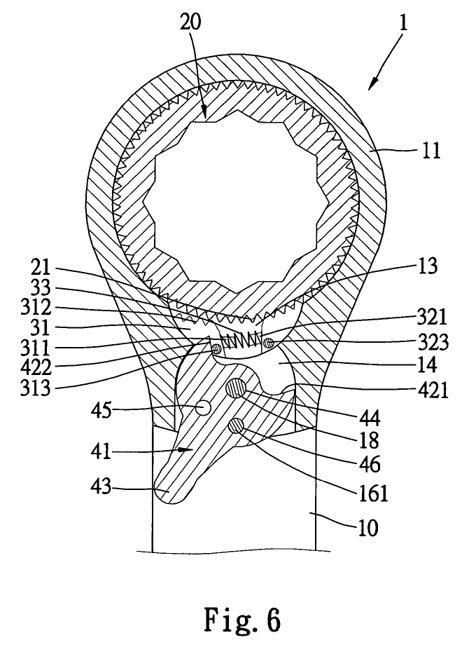

Referring to FIG. 6, the direction switch 40 is in a second position. The ball detent 16 enters the recess 46 so as to retain the direction switch 40 in the second position. The second end 422 of the wall of the space 42 pushes the rod 323. Thus, the pawl 32 is moved into a right-hand end of the crescent space 13. Thus, the head 11 can drive the annular gear 20 clockwise, but not vice versa.

The selective one-way wrench of the present invention exhibits several advantages. Firstly, its structure is simple. Secondly, the cost of using the threaded bolt 18 is low since it is not custom made. Thirdly, the installing of the direction switch 40 on the head 11 with the threaded bolt 18 is firm. Fourthly, the installing of the direction switch 40 on the head 11 with the threaded bolt 18 is easy.

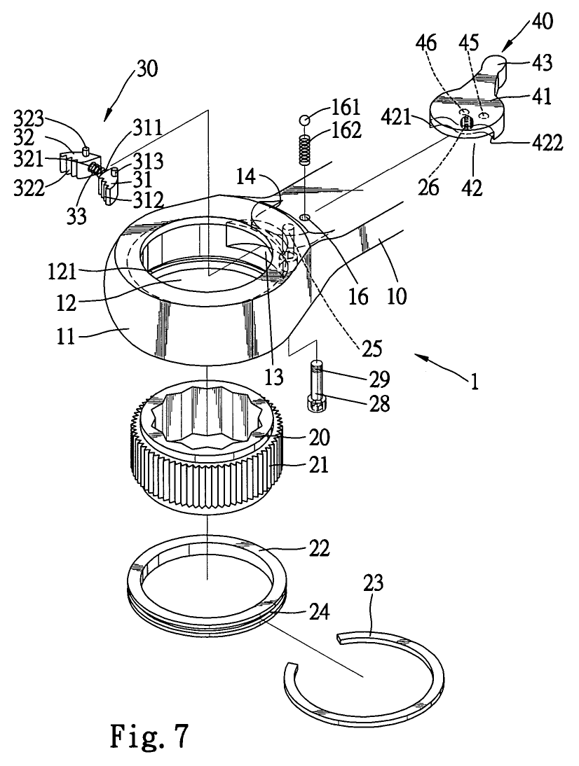

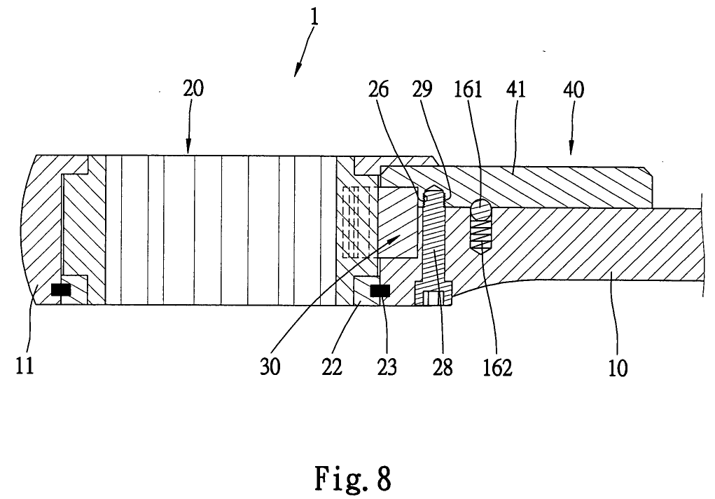

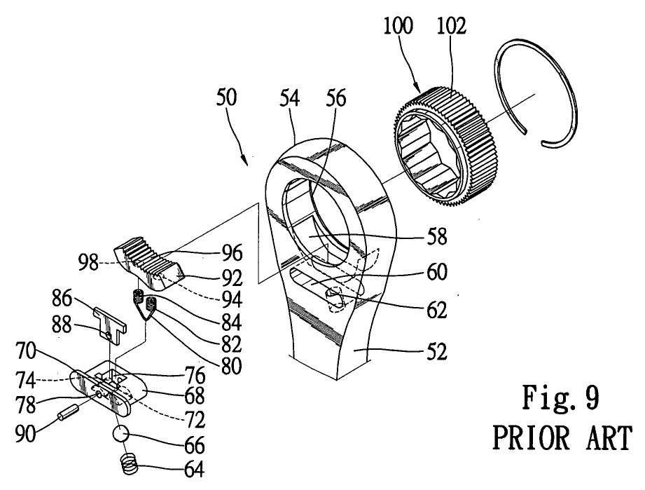

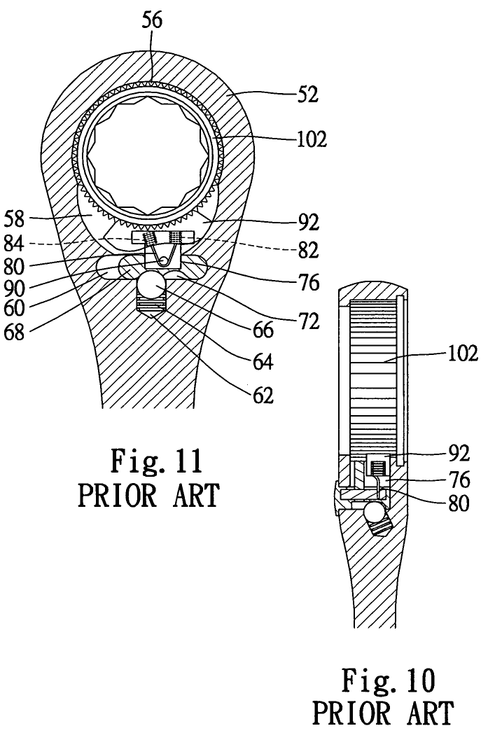

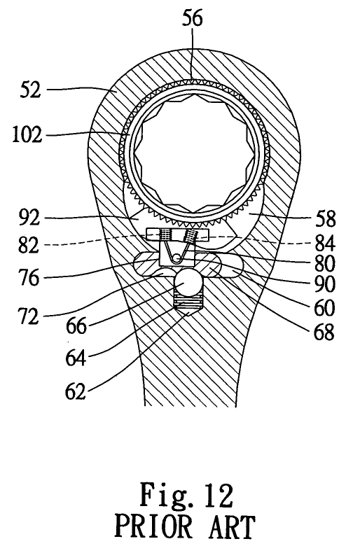

Referring to FIGS. 7 and 8, shown is a selective one-way wrench according to a second embodiment of the present invention. The second embodiment is like the first embodiment except several things. At first, an aperture 25 is made instead of the screw hole 15. Secondly, a fastener 28 is used instead of the fastener 18. The fastener 28 includes a threaded tip 29 and a smooth shank that is not threaded. Thirdly, a screw hole 26 is used instead of the recess 44. The threaded tip 29 of the fastener 28 is driven into the screw hole 26 while the smooth shank of the fastener 28 is rotationally positioned in the aperture 25. Thus, the direction switch 40 is pivotally installed on the head 11.

The present invention has been described through the illustration of the embodiments. Those skilled in the art can derive variations from the embodiments without departing from the scope of the present invention. Hence, the embodiments shall not limit the scope of the present invention defined in the claims.

1. A selective one-way wrench comprising:
a handle;
a head formed on the handle, the head defining a first space, a second space in communication with the first space, a third space in communication with the second space and an aperture;
an annular gear rotationally positioned in the first space;
a direction controller positioned in the second space, the direction controller comprising two pawls and a spring installed between the pawls;
a direction switch partially positioned in the third space for engaging selected one of the pawls with the annular gear, the direction switch defining a recess; and
a fastener driven into the recess of the direction switch through the aperture of the head so as to pivotally install the direction switch on the head.

2. The selective one-way wrench according to claim 1 wherein the first space is a circular space.

3. The selective one-way wrench according to claim 1 wherein the second space is a crescent space.

4. The selective one-way wrench according to claim 1 wherein the third space is a semi-circular space.

5. The selective one-way wrench according to claim 1 comprising a spring-biased detent, wherein the handle defines a recess for receiving the spring-biased detent, wherein the disc defines two recesses selected one of which receives the spring-biased detent so as to keep the disc in selected one of two positions.

6. The selective one-way wrench according to claim 1 wherein the direction switch comprises a disc partially positioned in the third space for engaging selected one of the pawls with the annular gear.

7. The selective one-way wrench according to claim 6 wherein each of the pawls comprises a rod, wherein the disc defines a space by means of a wall with two ends selected one of which can be engaged with the rod of selected one of the pawls so as to engage selected one of the pawls with the annular gear.

8. The selective one-way wrench according to claim 7 wherein the direction switch comprises a lever extending from the disc.

9. The selective one-way wrench according to claim 1 wherein each of the pawls comprises a boss fit in an end of the spring.

10. The selective one-way wrench according to claim 1 comprising a ring fit in the first space for supporting the annular gear.

11. The selective one-way wrench according to claim 10 comprising a clip, wherein the head defines an annular groove for receiving an external edge of the clip, wherein the ring defines an annular groove for receiving an internal edge of the clip.

12. The selective one-way wrench according to claim 1 wherein each of the pawls comprises a boss fit in an end of the spring.

13. The selective one-way wrench according to claim 1 wherein the fastener is a threaded bolt comprising a smooth tip, wherein the threaded bolt is driven into the screw hole of the head so that the smooth tip thereof is inserted into the recess of the direction switch, thus installing the direction switch on the head pivotally.

14. The selective one-way wrench according to claim 1 wherein the aperture of the head is a screw hole, wherein the recess of the direction switch is a smooth recess, wherein the fastener is a threaded bolt engaged with the screw hole of the head, wherein the threaded bolt comprises a smooth tip inserted into the smooth recess of the direction switch.

15. The selective one-way wrench according to claim 1 wherein the aperture of the head is a smooth aperture, wherein the recess of the direction switch is a screw hole, wherein the fastener is inserted through the smooth aperture of the head, wherein the fastener comprises a threaded tip engaged with the screw hole of the direction switch.
